(19) United States
(12) Patent Application Publication
(10) Pub. No.: US 2013/0124581 A1
(43) Pub. Date: May 16, 2013

(54) DATA PROCESSOR

(71) Applicants: Martti Tapani Ylikoski, Helsinki (FI); Ivan Bodunov, Espoo (FI); Martin Heisch, Berlin (DE); Sameer Babu Kunjumakal Kasim, Kerala (IN); Ricardo Marques, Azambuja (PT); Robert Pitchford, Basingstoke (GB)

(72) Inventors: Martti Tapani Ylikoski, Helsinki (FI); Ivan Bodunov, Espoo (FI); Martin Heisch, Berlin (DE); Sameer Babu Kunjumakal Kasim, Kerala (IN); Ricardo Marques, Azambuja (PT); Robert Pitchford, Basingstoke (GB)

(73) Assignee: NOKIA SIEMENS NETWORKS OY, Espoo (FI)

(21) Appl. No.: 13/697,200

(22) PCT Filed: Mar. 22, 2011
(86) PCT No.: PCT/EP11/54330

§ 371 Date: Jan. 22, 2013

(30) Foreign Application Priority Data
May 10, 2010 (US) 12776855

(51) Int. Cl. G06F 17/30

(52) U.S. Cl. CPC G06F 17/30312
USPC 707/812

(57) ABSTRACT

A system is described that generates reports from very large data sets. The reports are generated in real-time (or close to real time). Data from the large data set is replicated to a buffer as it arrives in the system. Once sufficient data is obtained (e.g. when the buffer is filled), the data is processed to generate a report. The report may summarize the data obtained and may be stored for later use. By storing summary data instead of the full data, the data storage requirements are reduced.

The present invention relates to the use of data, typically within very large data sets. Exemplary forms of the invention provide mechanisms for displaying data and for generating reports from data.

Management data relating to complex systems provides very large amounts of data. Furthermore, data is typically being added to the data set all the time. Management systems typically monitor management data in order, for example, to determine when a fault condition has occurred.

It is very difficult for reporting tools to extract the data required to prepare reports and to display data without affecting the performance of the management system. Clearly, it is important in such circumstances that report generation does not adversely impact on the ability of the management system to provide its primary role (such as monitoring for fault conditions).

One solution to the problem defined above is to copy data from the management system into a separate database that can be used by reporting tools to prepare reports. In such an arrangement, the reporting tools do not need to access the main management system data and so the running of reports has no impact on the normal running of the management system.

Although the copying of management data into a separate database is conceptually simple, there are problems. For example, in systems with very large data sets, the copying of data may take a significant amount of time, which may itself affect the performance of the management system. Further, the quantity of data typically included in a management system can make the redundant storage required by such an algorithm relatively expensive. Finally, such an arrangement typically regularly transfers a defined data set to a temporary store.

Working on very large data sets can often result in low performance of report generating tools.

The present invention seeks to address at least some of the problems outlined above.

The present invention provides an apparatus (such as a report generator) comprising: a first input for receiving data from a data set; a first storage means for storing the received data; and a first processor for generating a report based on said first data, wherein, the data stored in said storage means is over-written once the report is generated.

The present invention also provides a method comprising: receiving first data from a data set; storing said first data (typically using a first storage means); processing said first data to generate a first report; and over-writing said stored first data after said first report is generated.

The reports are typically generated in real-time (or close to real time). Thus, as data arrives at a system, it is replicated at the processor of the present invention and used to generate the said reports.

In some forms of the invention, the report provides a summary of the received data. By way of example, the summary of the data may be stored, rather than the full data set, in order to reduce data storage requirements whilst retaining the ability to review data over a long period of time.

The invention may further comprising receiving second data from said data set; storing said second data by over-writing said stored first data; and processing said second data to generate a second report. Thus, data may be received, stored in a buffer, a report generated (in or close to real-time) and the data then over-written with new data so that a new report can be generated.

Alternatively, the invention may further comprise receiving second data from said data set; storing said second data in a different location to said first data; processing said second data to generate a second report; and over-writing said stored second data after said second report is generated. Thus, data may be received, stored in a buffer, and a report generated. When further data is received, this is replicated to a different storage mechanism so that the first data can be processed even after the second data is received. This provides additional time for the report generation process to be completed.

Thus, the present invention describes an apparatus, a method and a system that can be used for generating reports from very large data sets. The reports may be generated in real-time (or close to real time). Data from the large data set is replicated to a buffer as it arrives in the system. Once sufficient data is obtained (e.g. when the buffer is filled), the data is processed to generate a report. The report may summarise the data obtained and may be stored for later use. By storing summary data instead of the full data, the data storage requirements are reduced.

The present invention also provides a computer program comprising: code (or some other means) for receiving first data from a data set; code (or some other means) for storing said first data; code (or some other means) for processing said first data to generate a first report; and code (or some other means) for over-writing said stored first data after said first report is generated. The computer program may be a computer program product comprising a computer-readable medium bearing computer program code embodied therein for use with a computer.

Exemplary embodiments of the invention are described below, by way of example only, with reference to the following numbered schematic drawings.

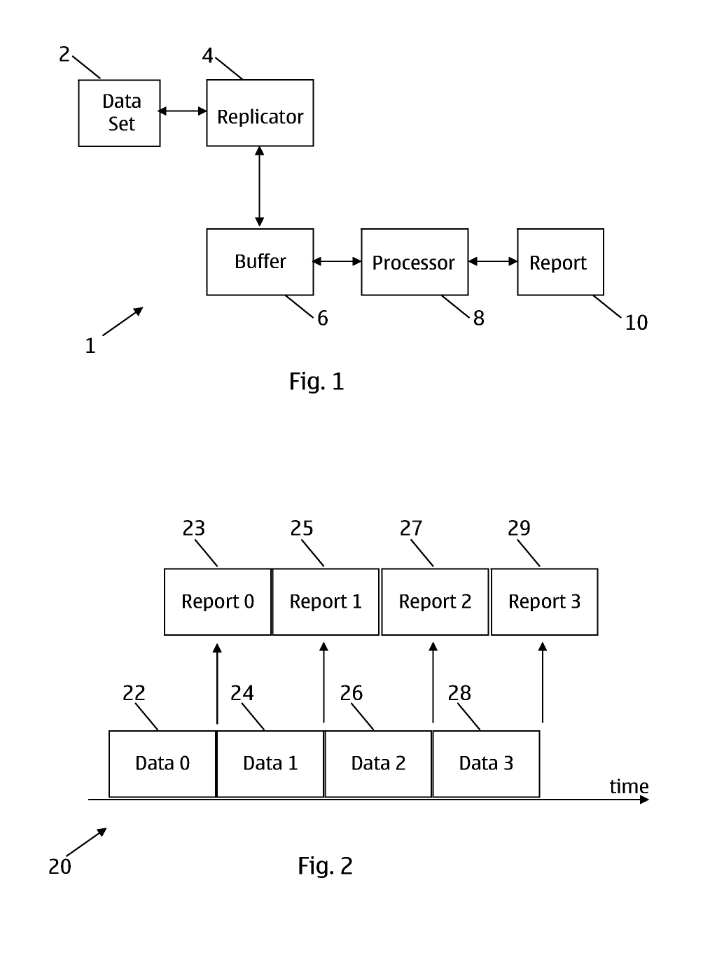

FIG. 1 is a block diagram of a system in accordance with an aspect of the present invention;

FIG. 2 is a timeline showing an exemplary use of the system of FIG. 1;

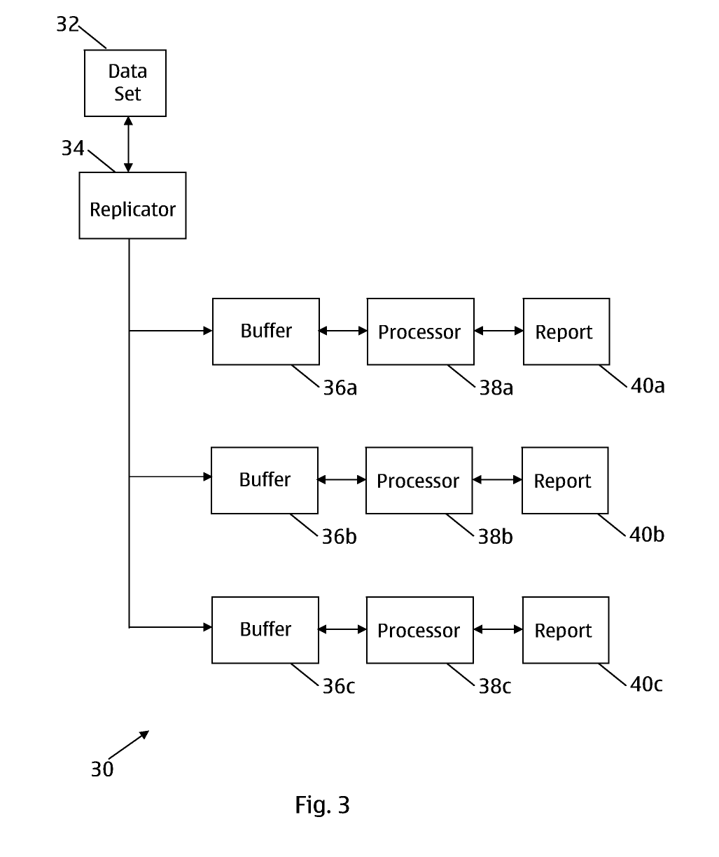

FIG. 3 is a block diagram of a system in accordance with an aspect of the present invention; and

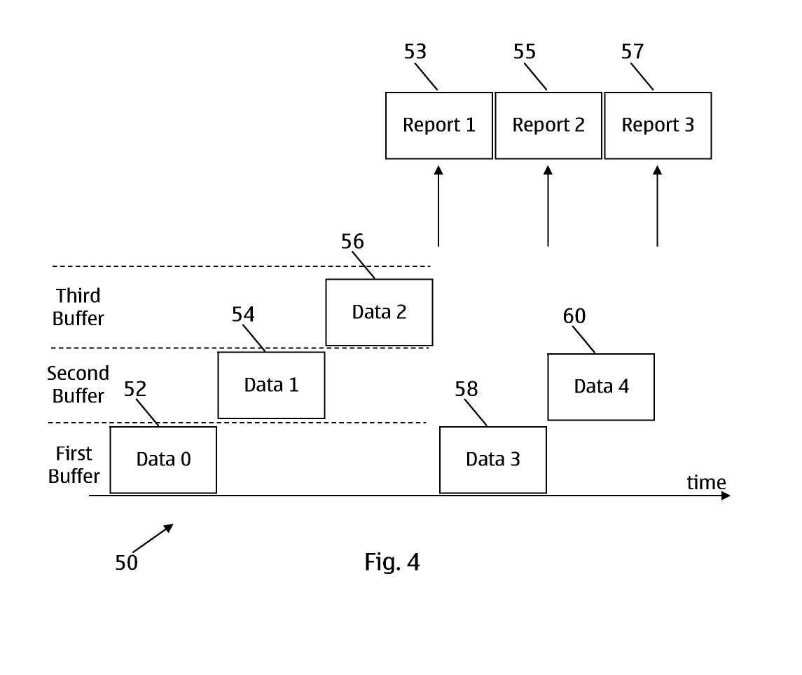

FIG. 4 is a timeline showing an exemplary use of the system of FIG. 3.

FIG. 1 is a block diagram of a system, indicated generally by the reference numeral 1, in accordance with an aspect of the present invention. The system comprises a data set 2, a data replicator 4, a buffer 6 and a processor 8. The processor 8 generates a report 10.

The data set 2 may be provided by a management system. Typically, the data set 2 provides data on a periodic (and/or regular) basis. Over time, the quantity of data provided by the data set 2 can become very large indeed. A further difficulty in handling such data is that data is continually arriving and therefore continually requiring processing.

The processor is adapted to take data obtained from the data set 2 and produce one or more reports. The format of the data and the nature of the reports can be extremely varied. By way of example only, the data set 2 may provide data concerning system faults. The data may include variables such as the nature of the fault, the location of the fault, the time taken to fix the fault etc. The report can generate a summary of the fault information provided in the data set 2.

In one exemplary form of the system, the processor 8 takes data over a predetermined period of time and summarises the data in the report 10. For example, in the example described above, fault information provided by the data set 2 may be summarised by simply recording the number of faults in any particular location and the average time taken to address those faults at that location.

In the system 1, the replicator is used to fill the buffer 6 with data relating to a predetermined time period. Once the buffer is full, the processor 8 is used to process the data in the buffer to generate the report 10. With the report generated, the replicator 4 can start to refill the buffer 6 with data relating to the next time period. The functionality of the replicator 4 and the buffer 6 may be provided as a single module. The functionality of the buffer 6 and the processor 8 may be provided as a single module. The functionality of the replicator 4, the buffer 6 and the processor 8 may be provided as a single module.

The situation described above is in the timeline of FIG. 2, which timeline is indicated generally by the reference numeral 20.

The timeline 20 starts with data 22 being provided to the buffer 6. When a predetermined period of time has elapsed, the data 22 is considered to be complete and a report 23 is generated.

Once the report 23 has been generated, the process is repeated so that the buffer is cleared (generally by being over-written rather than by being actively cleared as a whole) and a new set of data (date 24) fills the buffer. Once the buffer is full, a report 25 is generated. Then, the buffer is refilled with data 26 and a further report 27 is generated. Next, the buffer is refilled with data 28 and a further report 29 is generated. The buffer 6 may be filled as data arrives from the data set 2. Alternatively, the buffer 6 may be filled in parallel with a batch of data being provided the replicator 4.

The reports 23, 25, 27 and 29 are generated in real-time (or in almost real-time). The storage requirements of the buffer 6 are relatively limited, since the buffer only needs to store the most recent incoming data. The storage requirements related to the reports themselves will generally be very much more limited that the storage requirements of the original data. Accordingly, the system 1 enables reports to be generated as data is coming into the system 1 and allows the reports to be stored for later referral. This dramatically reduces data storage requirements, whilst enabling near real-time analysis of the data. Whilst data storage is kept to a minimum, data selected for storage in the reports can be retained for later use. For example, reported can be processed on a continuous basis and data displayed later showing changes in data over a very long period of time.

The use of a separate replicator 4 and buffer 6 as shown in FIG. 1 is not an essential requirement of the invention.

What is required is that the incoming data is presented to the processor 8 in a suitable format for generating the report 10 and is then discarded. Data is typically discarded by over-writing the data with new data. If the processor can generate reports quickly enough, data can be fed from the data set 2 direct to the buffer (on a first-in-first-out basis) and the report generated when the buffer is full. A mechanism (perhaps part of the processor 8) is needed to determine when the processor is full (i.e. to determine when to generate the next report).

The system 1 requires reports to be generated at least as quickly as data is input from the data set 2. This is not always possible.

FIG. 3 is a block diagram of a system, indicated generally by the reference numeral 30, in accordance with a further aspect of the present invention. The system 30 comprises a data set 32 that is similar to the data set 2 described above. The system also comprises a replicator 34, a first buffer 36a, a second buffer 36b, a third buffer 36c, a first processor 38a, a second processor 38b, and a third processor 38c. In use, the first processor 38a generates a first report 40a, the second processor 38b generates a second report 40b and the third processor 38c generates a third report 40c.

The replicator 34 routes data provided by the data set 32 to one of the first, second and third buffers. When the first buffer 36a is full (or sufficiently full to generate the report 40a), the first processor 38a processes that data in order to generate the first report 40a. Similarly, when the second buffer 36b is full (or sufficiently full), the second processor 38b processes that data in order to generate the second report 40b. Also, when the third buffer 36c is full (or sufficiently full), the third processor 38c processes that data in order to generate the third report 40c.

FIG. 4 is a timeline, indicated generally by the reference numeral 50, showing an exemplary use of the system of FIG. 3.

As shown in the timeline 50, the replicator 34 routes a first set of data (data 0) to the first buffer. Once the first set of data has been received, the first processor 38a starts to process that data.

A second set of data (data 1) is routed by the replicator 34 to the second buffer 36b and the second processor 38b starts to process that data. A third set of data (data 2) is routed by the replicator 34 to the third buffer 36c and the third processor 38c starts to process that data.

At this stage, all of the buffers 36a, 36b and 36c are full. The next data set (data 3) is routed to the first buffer 36a and starts to over-write the first data set (data 0). However, before the over-writing starts, the first processor 38a has completed a report 53 (the report 1 shown in FIG. 4) based on the first data (data 0). Similarly, by the time the next data set (data 4) is routed to the second buffer 36b, the second processor 38b has generated a report 55 (the report 2 shown in FIG. 4) based on the second data (data 1).

Thus, the system of FIG. 3 gives the processors 38a, 38b and 38c more time to process the real-time data that is received from the data set 32. Clearly, more or fewer processors could be provided in order to provide more or less time for each processor to generate each report.

The embodiments of the invention described above are illustrative rather than restrictive. It will be apparent to those skilled in the art that the above devices and methods may incorporate a number of modifications without departing from the general scope of the invention. It is intended to include all such modifications within the scope of the invention insofar as they fall within the scope of the appended claims.

1. An apparatus comprising:
a first input for receiving data from a data set;
a first storage means for storing the received data; and
a first processor for generating a report based on said first data,
wherein, the data stored in said storage means is over-written once the report is generated.

2. An apparatus as claimed in claim 1, wherein the report provides a summary of the received data.

3. An apparatus as claimed in claim 1, further comprising a second storage means and a second processor, wherein a first set of received data is stored in said first storage means and a second set of data, received after said first set, is stored in said second storage means, and where said second processor generated a second report based on said second data.

4. A method comprising:
receiving first data from a data set;
storing said first data;
processing said first data to generate a first report; and
over-writing said stored first data after said first report is generated.

5. A method as claimed in claim 4, wherein the first report provides a summary of the first set of received data and the second report provides a summary of the second set of received data.

6. A method as claimed in claim 4 or claim 5, further comprising:
receiving second data from said data set;
storing said second data by over-writing said stored first data; and
processing said second data to generate a second report.

7. A method as claimed in claim 4 or claim 5, further comprising:
receiving second data from said data set;
storing said second data in a different location to said first data;
processing said second data to generate a second report; and
over-writing said stored second data after said second report is generated.

8. A computer program product comprising:
means for receiving first data from a data set;
means for storing said first data;
means for processing said first data to generate a first report; and
means for over-writing said stored first data after said first report is generated.
